(19) United States
(12) Patent Application Publication
(10) Pub. No.: US 2010/0308061 A1
(43) Pub. Date: Dec. 9, 2010

(54) SYSTEM, METHOD AND APPARATUS FOR CONTAINER INDICIA

(76) Inventor: Demetre Loulourgas, Belleair, Beach, FL (US)

Correspondence Address: LARSON AND LARSON, 11199 69TH STREET NORTH, LARGO, FL, 33773, US

(21) Appl. No.: 12/478,050

(22) Filed: Jun. 4, 2009

(51) Int. Cl. B65D 81/38; B23P 17/00

(52) U.S. Cl. 220/592.2; 29/592

(57) ABSTRACT

An application for an insulated container or cup that has an outer container member that is transparent and an inner container member onto which an indicia is made by laser etching. The inner container member fits within the outer container member and is affixed to a rim of the outer container member, thereby forming a gap between the inner container member and the outer container member.

### FIELD OF THE INVENTION

This invention relates to the field of beverage cups and more particularly to an insulated container having laser-etched indicia.

### BACKGROUND

Hot and cold drinks are often enjoyed from cups by many. If the drinks are too hot, the cup may be uncomfortable for one to hold for long periods of time. If the drinks are cold, the cup often perspires from humidity in the air, especially in humid locals.

To combat these problems, insulated drinking cups have been made having an outer cup portion and an inner cup portion separated by a gap in which the gap is usually filled with air or partially evacuated. The gap serves as an insulator so that heat or cold from the hot or cold liquid heats up the inner cup portion, but the gap reduces conductive heating or cooling of the outer cup portion. Therefore, the outer cup portion does not heat or cool as much, thereby making it more comfortable to hold and reducing condensation. One such cup is described in U.S. Pat. No. 6,161,720 to Castle. Another double-walled drinking vessel is described in U.S. Pat. Pub. 2007/0154665 to Cheng. This drinking vessel has an optional ornamental design, a first part of which is applied to the outer layer and a second part of which is applied to the inner layer.

Another insulated cup is described in U.S. Pat. Pub. 2008/0302800 to Chou. This does not have indicia.

Likewise, other insulated containers utilize the same two-part approach. For example, a sealable storage container having an inner member and an outer member separated by a gap for storing food and keeping it either warm or cool. Often, these containers are made of a clear material so as to make the contents visible from the outside.

Often, it is desired to place indicia on the drinking cup or container to personalize the cup with a person's name, to make the cup a novelty item with a team name, team logo, vacation spot, etc or to make the cup an advertisement for a company or event such as a brand name, the Olympics, World Series, etc. Such indicia is often painted or decaled on an outside surface of the cup as well known in the art of coffee mugs, shot glasses, wine glasses and the like.

In the art of insulated cups, the cups are often made of a clear plastic. The inner cup member is smooth or has ridges or other geometric designs. In such clear plastic insulated cups, it is often practiced to place indicia between the inner cup member and the outer cup member, since it is visible through the clear outer cup member. This is often accomplished using a sticker, decal or embroidered part, adding a manual step to the manufacturing process. There are several reasons for locating the indicia on the inner cup member (in the gap). The outer cup member protects the indicia from abrasion, discoloration, peeling, etc. Additionally, since the indicia are not in contact with the person holding the cup, the outer surface of the cup is smooth and uninterrupted.

Prior to the placement of the indicia in between the inner cup member and the outer cup member (or inner container member and outer container member), it was simple to recycle the plastic at the end of life—grind and reuse for new products. Once the indicia are added, the cup or container need be broken and the indicia removed before grinding, creating an extra step that increases the cost of recycling.

What is needed is a system, method and apparatus that will provide indicia directly on the inner cup or container member.

### SUMMARY OF THE INVENTION

The present invention includes an insulated cup or container and a method of making the insulated cup or container. The insulated cup or container has an outer cup or container member that is transparent and an inner cup or container member onto which an indicia is made by laser etching. The inner cup or container member fits within the outer cup or container member and is affixed to a rim of the outer cup or container member, thereby forming a gap between the inner cup or container member and the outer cup or container member.

In one embodiment, an insulated container is disclosed including an outer c container up member made of a material and having an opening with a rim around the opening. The container also includes an inner container member sized to fit within the outer container member. The inner container member has an overlap edge lip which is affixed to the rim of the outer container member, thereby forming a gap between the outer container member and the inner container member. Indicia is etched onto an outer surface of the inner container member, the indicia etched with a laser and visible through the outer container member.

In another embodiment, a method of making an insulated container is disclosed including providing an outer container member made of a material (e.g., transparent plastic) and having an opening with a rim around the opening. An inner container member sized to fit within the outer container member is provided. The inner container member has an overlap edge lip for affixing to the rim of the outer container member. Indicia are etched onto an outer surface of the inner container member by a laser. The inner container member is positioned within the outer container member and the rim is affixed to the overlap edge lip.

In another embodiment, an apparatus for containing a liquid is disclosed including an outer cup member made of a transparent plastic material and having an opening at a top surface with a rim around the opening. The apparatus also has an inner cup member of a size to fit within the outer cup member. The inner cup member has an opening at a top surface with an overlap edge lip at the opening. The overlap edge lip is affixed to the rim of the outer cup member, thereby forming a gap between the outer cup member and the inner cup member. Indicia are etched onto an outer surface of the inner cup member with a laser and are visible through the outer cup member.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates the system and apparatus of a first embodiment of the present invention.

FIG. 1A illustrates the system and apparatus of a first embodiment of the present invention in which the container is a cup and has internal ribs.

FIG. 2 illustrates an exploded view of a cup of the present invention.

FIG. 3 illustrates a perspective view of a cup of the present invention.

FIG. 4 illustrates a schematic view of a system and apparatus of a first embodiment of the present invention showing different indicia.

FIG. 5 illustrates a perspective view of a mug of the present invention.

FIG. 6 illustrates a perspective view of a container of the present invention.

FIG. 7 illustrates a flow chart of the present invention.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures. Much of the description relates to a cup or drinking cup but other forms, shapes and sizes of containers are clearly anticipated including, but not limited to, food storage containers, coffee mugs and water bottles.

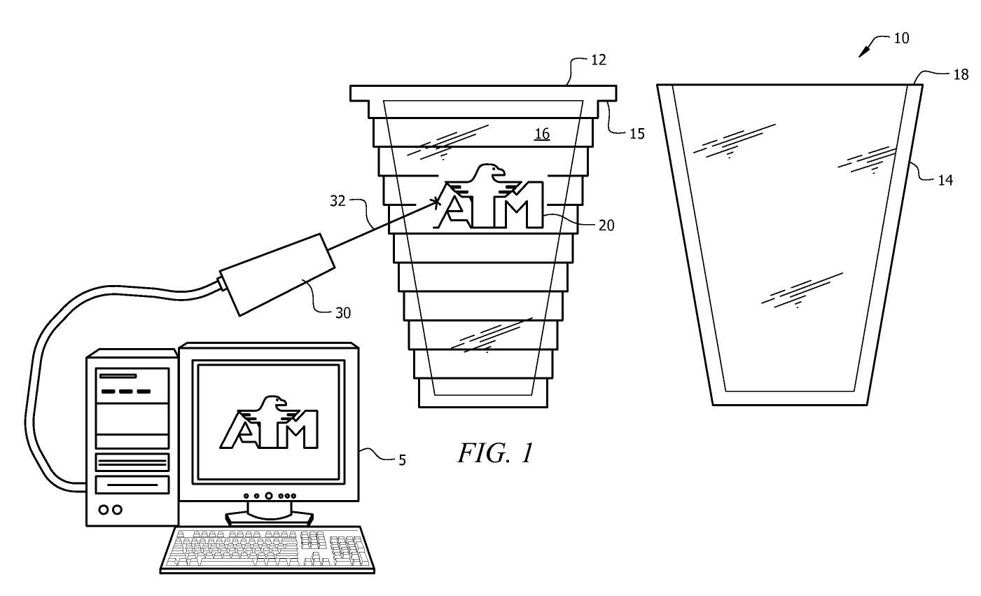

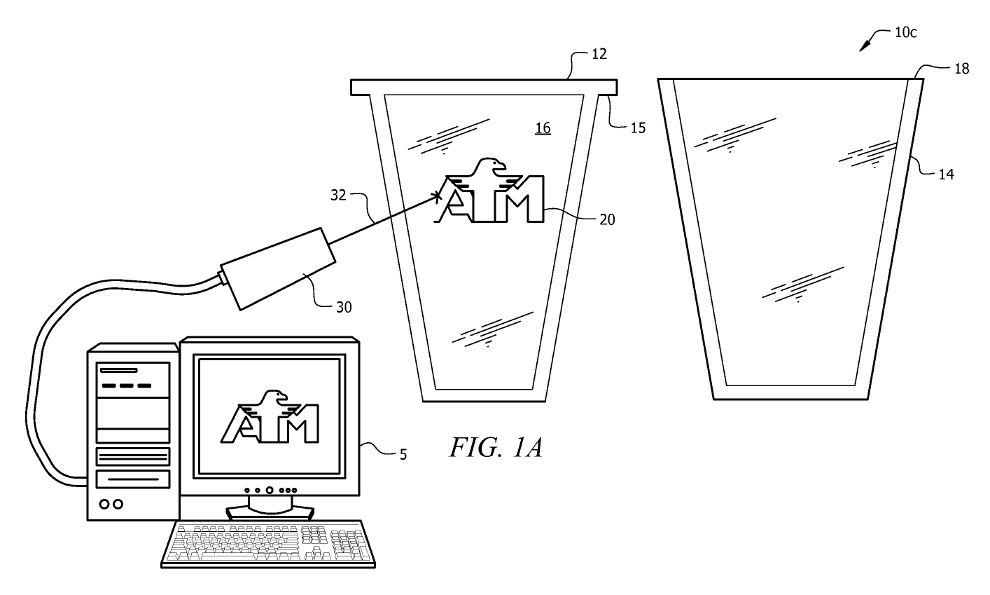

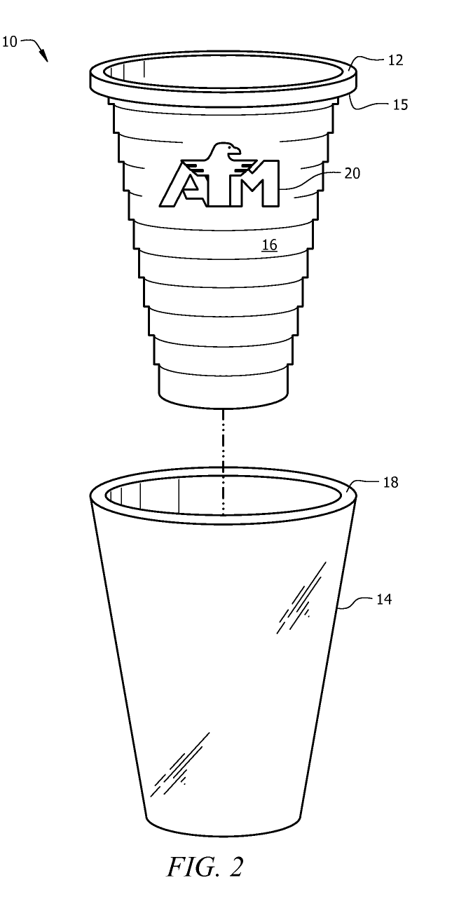

Referring to FIG. 1, a view of a cup 10 of a first embodiment of the present invention will be described with respect to a drinking cup, but any form of container is anticipated. The insulated cup 10 includes an outer cup member 14 having an open top with a rim 18 and an inner cup member 12 having an open top with an overlap edge lip 15. The inner cup member 12 fits within the outer cup member 14 and the rim 18 interfaces with the overlap edge lip 15. As is shown in FIG. 2, the inner cup member 12 fits into the outer cup member 14, providing a gap between an outer surface of the inner cup member 12 and an inner surface of the outer cup member 14. This gap provides an insulation layer between the inner cup member 12 and the outer cup member 14 to reduce conduction of heat/cold from a liquid within the inner cup member 12 to the outer cup member, thereby maintaining an outer cup member temperature that is closer to ambient temperature than to the liquid held in the inner cup member 12. The inner cup member 12 and the outer cup member 14 are made of a material such as plastic, nylon, polycarbonate or any other clear material. It is preferred that the outer cup member 14 be made of a transparent or translucent material such as clear plastic. In some embodiments, the inner cup member 12 is transparent.

Although any gas is anticipated to be within the gap, air or a partial vacuum is preferred. This provides sufficient resistance to heat conduction between the inner cup member 12 and the outer cup member 14.

In the prior art, indicia is often included between the inner cup member 12 and the outer cup member 14 and visible through the transparent or translucent outer cup member 14. In the prior art, the indicia is provided as a sticker/decal or as an embroidered cloth. This requires placement, alignment and adhering of the indicia on the outside surface 16 of the inner cup member 12 before the inner cup member 12 is inserted into the outer cup member 14. In the prior art, the indicia is subject to falling off, discoloring from temperature extremes and other issues. Such prior art indicia looks good from the front, but the back-side does not looks as well, especially when the indicia is embroidered. Furthermore, since a second material is introduced within the cup/container of the prior art, recycling is impacted since the cup/container need be broken apart to extract the foreign substance before the plastic part is recycled.

The present invention overcomes the issues of the prior art by using a laser 30 to etch the indicia 20 onto the outside surface 16 of the inner cup member 12. The laser 30 emits a high-intensity, very directional light beam 32 that etches the indicia 20 into the outside surface 16. Since the laser 30 is easily programmed using computer control 5, this method creates permanent indicia 20 on the outside surface 16. Furthermore, since it is computer controlled 5, it is a simple task to change indicia 20, thereby enabling single cup lots. Furthermore, the computer control 5 is also programmable to compensate for uneven surfaces on the outer surface 16. The laser etching looks good from both the front and the back of the indicia 20 and, since the indicia is not a foreign material such as cloth, the resulting product (container, cup, etc) is easily recycled.

Any indicia is anticipated, including but not limited to, locality names (e.g., Clearwater Fla.), team names (e.g., Tampa Bay Rays), logos, slogans, company names, family names, first names, etc.

Referring to FIG. 1A, a view of a second exemplary cup 10c of the present invention will be described. This exemplary cup 10c is constructed, marked and assembled as the cup 10 of FIG. 1. The difference is that the inner member 12 has smooth walls whereas the inner member 12 of the cup 10 has ribs or other irregular surfaces.

Referring to FIG. 2, an exploded view of an apparatus of the present invention will be described. Once the indicia 20 is etched onto the outside surface 16 of the inner cup member 12, the inner cup member 12 is inserted into the outer cup member 14 and sealed between the rim 18 of the outer cup member 14 and the overlap edge lip 15 of the inner cup member 12. It is anticipated that the seal is made using an adhesive, ultrasonic weld, a pressure fit, etc, as known in the industry.

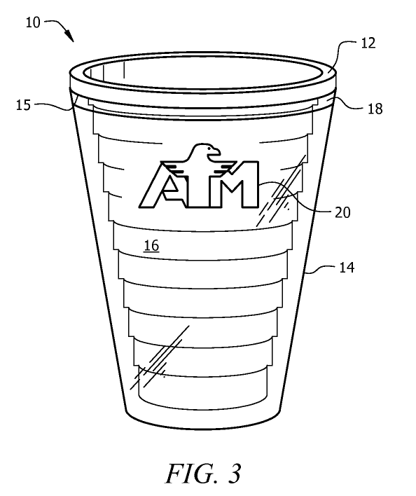

Referring to FIG. 3, a perspective view of the present invention will be described. The inner cup member 12 is now within the outer cup member 14 and sealed. The indicia 20 is visible through the clear or translucent outer cup member 14.

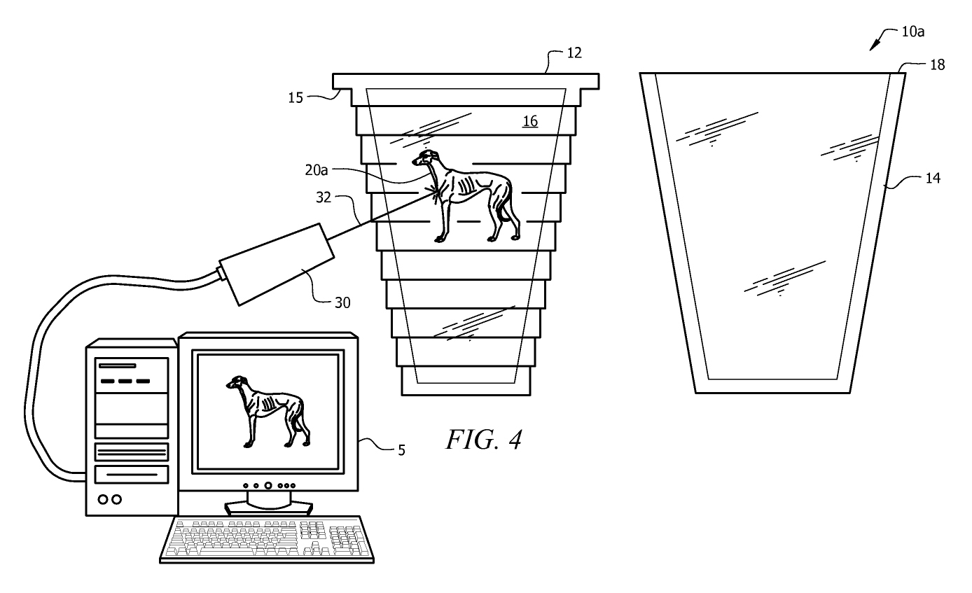

Referring to FIG. 4, a schematic view of a system and apparatus of a first embodiment of the present invention showing different indicia 20a will be described. Again, the insulated cup 10a includes an outer cup member 14 having a rim 18 and an inner cup member 12 having an overlap edge lip 15. As is shown in FIG. 2, the inner cup member 12 fits into the outer cup member 14, providing a gap between an outer surface of the inner cup member 12 and an inner surface of the outer cup member 14. This gap provides an insulation layer between the inner cup member 12 and the outer cup member 14 to reduce conduction of heat/cold from a liquid within the inner cup member 12 to the outer cup member, thereby maintaining an outer cup member temperature that is closer to ambient temperature than to the liquid held in the inner cup member 12.

The present invention overcomes the issues of the prior art by using a laser 30 to etch the indicia 20a onto the outside surface 16 of the inner cup member 12. The laser 30 emits a high-intensity, very directional light beam 32 that etches the indicia 20a into the outside surface 16. Since the laser 30 is easily programmed using computer control 5, this method creates permanent indicia 20a on the outside surface 16. Furthermore, since it is computer controlled 5, it is a simple task to change indicia 20a as shown in FIG. 4 with respect to the indicia 20 of FIG. 1, thereby enabling single cup lots. Furthermore, the computer control 5 is also programmable to compensate for uneven surfaces on the outer surface 16.

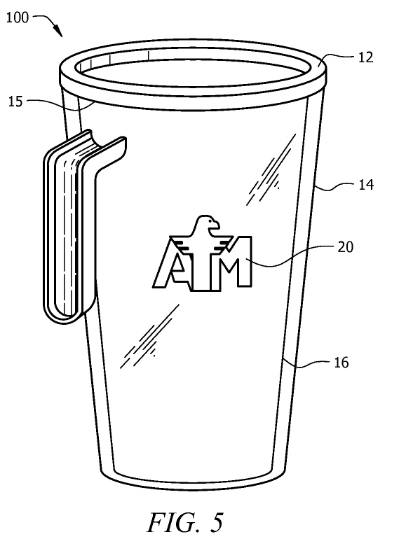

Referring to FIG. 5, a perspective view of a mug 100 of the present invention is shown. The mug 100 is similar to the cup 10 with the addition of a handle. The indicia 20 are visible through the outer member 12.

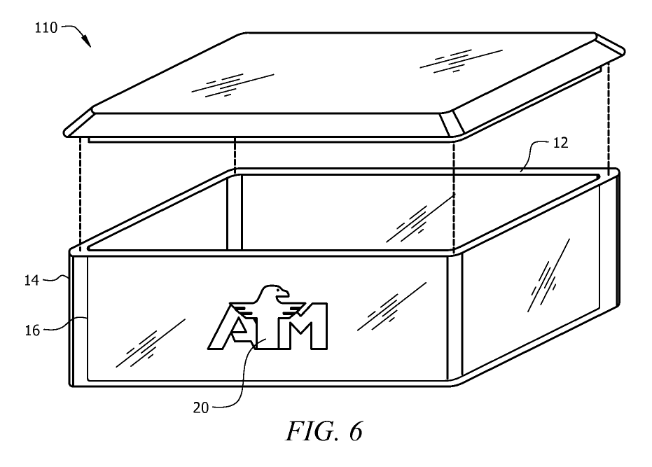

Referring to FIG. 6, a perspective view of a container 110 of the present invention is shown. The container 110 is an example of one possible shape, rectangular. Any other shape is anticipated, for example cylindrical with a flat top and flat bottom. Again, the indicia 20 is visible through the outer member 12

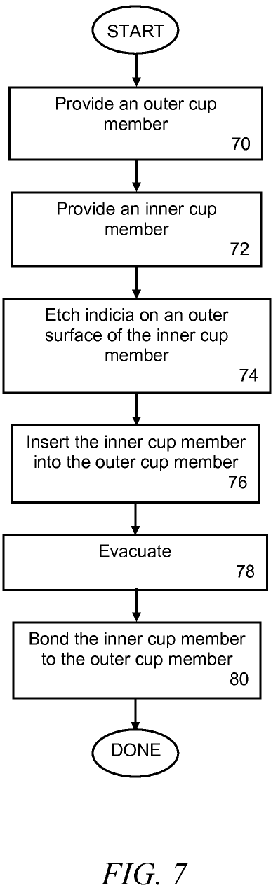

Referring to FIG. 7, a flow chart of the present invention is shown. The method of making the insulated cup of the present invention includes providing 70 an outer cup member 14 and providing 72 an inner cup member 12. It is anticipated that the inner cup member 12 and the outer cup member be made by a process known in the industry such as injection molding.

The next step is to etch 74 indicia 20 onto an outer surface 16 of the inner cup member 12. This step is performed using a laser 30, preferably controlled by a computer 5. Once the indicia 20 is etched 72 on the outer surface 16, the inner cup member 12 is inserted 76 into the outer cup member 14 and, optionally, air is evacuated 78 from the gap between the inner cup member 12 and the outer cup member 14. Finally, the inner cup member 12 is bonded 80 to the outer cup member 14 with an adhesive, ultrasonic weld or any known method of bonding such parts.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An insulated container comprising:
an outer container member, the outer container member made of a material, the outer container member having an opening and a rim around the opening;
an inner container member, the inner container member of a size to fit within the outer container member, the size providing a gap between the outer container member and the inner container member, the inner container member having an overlap edge lip, the overlap edge lip affixed to the rim of the outer container member; and
an indicia etched onto an outer surface of the inner container member, the indicia etched with a laser and the indicia visible through the outer container member.

2. The insulated container of claim 1, wherein the material is a transparent plastic.

3. The insulated container of claim 1, wherein the material is a translucent plastic.

4. The insulated container of claim 1, wherein the material is polycarbonate.

5. The insulated container of claim 1, wherein the overlap edge lip is affixed to the rim of the outer container member by an adhesive.

6. The insulated container of claim 1, wherein the overlap edge lip is affixed to the rim of the outer container member by ultrasonic welding.

7. The insulated container of claim 1, wherein the gap is partially evacuated.

8. A method of making an insulated container, the method comprising:
providing an outer container member, the outer container member made of a material, the outer container member having an opening and a rim around the opening;
providing an inner container member, the inner container member of a size to fit within the outer container member, the size such that a gap is between the outer container member and the inner container member, the inner container member having an overlap edge lip, the overlap edge lip sized and positioned to interface with the rim of the outer container member;
etching an indicia onto an outer surface of the inner container member, the etching performed with a laser;
placing the inner container member into the outer container member so that the overlap edge lip interfaces with the rim of the outer container member; and
affixing the rim to the overlap edge lip.

9. The method of claim 8, wherein the material is a clear plastic.

10. The method of claim 8, wherein the step of etching is controlled by a computer.

11. The method of claim 8, wherein the step of affixing the rim of the outer container member to the overlap edge lip of the inner container member includes applying an adhesive to the rim of the outer container member and joining the rim of the outer container member to the overlap edge lip of the inner container member.

12. The method of claim 8, wherein the step of affixing the rim of the outer container member to the overlap edge lip of the inner container member includes ultrasonic welding of the rim of the outer container member to the overlap edge lip of the inner container member.

13. The method of claim 8, further comprising a step of partially evacuating the gap before the step of affixing.

14. An apparatus for containing a liquid, the apparatus comprising:
an outer cup member, the outer cup member made of a transparent plastic material, the outer cup member having an opening at a top surface and a rim around the opening;
an inner cup member, the inner cup member of a size to fit within the outer cup member and the size providing a gap between the outer cup member and the inner cup member, an opening at a top surface of the inner cup member has an overlap edge lip, the overlap edge lip is affixed to the rim of the outer cup member; and
an indicia etched onto an outer surface of the inner cup member, the indicia etched with a laser and the indicia visible through the outer cup member.

15. The insulated cup of claim 14, wherein the inner cup member is made from the transparent plastic.

16. The insulated cup of claim 14, wherein the inner cup material is made of a translucent plastic.

17. The insulated cup of claim 14, wherein the laser is computer controlled.

18. The insulated cup of claim 14, wherein the overlap edge lip is affixed to the rim of the outer cup member by an adhesive.

19. The insulated cup of claim 14, wherein the overlap edge lip is affixed to the rim of the outer cup member by ultrasonic welding.

20. The insulated cup of claim 14, wherein the gap is partially evacuated.
